(19) United States
(12) Patent Application Publication
(10) Pub. No.: US 2012/0234180 A1
(43) Pub. Date: Sep. 20, 2012

(54) WATER VENTING SYSTEMS AND METHODS FOR AIRCRAFT BEVERAGE MAKERS

(76) Inventor: RACHEL Kuniyoshi Cabe, Centerville, VA (US)

(21) Appl. No.: 13/417,529

(22) Filed: Mar. 12, 2012

Related U.S. Application Data
(60) Provisional application No. 61/451,684, filed on Mar. 11, 2011.

(51) Int. Cl. A47J 31/46; F15B 13/02

(52) U.S. Cl. 99/275; 137/596

(57) ABSTRACT

Embodiments of the present invention provide improved draining and venting systems for coffee makers and other water-using appliances used on board passenger transport vehicles.

This application claims the benefit of U.S. Provisional Application Ser. No. 61/451,684, filed Mar. 11, 2011 titled “Hot Water Venting Scheme for Aircraft Coffee Maker,” the entire contents of which are hereby incorporated by reference.

### FIELD OF THE INVENTION

Embodiments of the present invention relate generally to methods and systems for venting beverage makers for use on board passenger transport vehicles, and in specific embodiments, the coffee makers for use in aircraft galleys. Various embodiments provide water venting features that allow water to drain or vent from the flow tubes of the drain system.

### BACKGROUND

In general, coffee or other beverage makers used on board passenger transport vehicles are in fluid or direct connection with the aircraft or vehicle water supply. This is particularly the case with coffee makers mounted on board commercial aircraft, which are plumbed directly into the aircraft's potable water tanks This configuration is in stark contrast to a typical residential or commercial coffee maker that sits on a countertop, plugs into an outlet, and uses an external water supply. For coffee makers that use an external water supply, there is lower likelihood of water drainage issues. In other words, there is not a connected water system that could potentially house and store unused drain fluid, potentially causing trapped water and creating an environment for growth of unsanitary bacteria.

In use, when water is delivered to a coffee or other beverage maker from an on-board water tank, the water flows into the coffee maker tank, and the overflow is delivered to the brew basket. Once the inlet valve is shut off, the water flow is stopped, but there is still water in the tubing between the tank and the brew basket, which can an array of problems. There is not currently a solution to this problem—most on-board beverage makers simply allow the water to remain trapped in the tubing.

More specifically, many aircraft beverage maker designs rely on solenoid valves to control the flow of hot water from the hot water tank or supply to the areas of the unit that require hot water for actions such as coffee brewing, tea brewing, hot water dispensing, and do forth. An inlet solenoid usually allows a flow of inlet water that supplies the beverage maker with cold supply water, pushing the heated water out to the desired application. When this inlet solenoid closes, the hot water inside the internal tubing system of the beverage maker is trapped, as there is no way for air to enter the system and vent the remaining water. This creates a potential unsanitary condition in that trapped hot-to-warm water in the tubes can provide a breeding ground for bacteria. In can also create dripping problems. Additionally, trapped water in the tubing system also presents a damage risk to the unit in the case that it is subjected to freezing conditions, as the water in the tubing could expand and damage internal components.

Accordingly, it is desirable to provide effective venting solutions for controlling the flow of water to and from beverage makers on-board passenger transport vehicles.

### BRIEF SUMMARY

Embodiments of the present invention provide improved venting solutions for coffee and other beverage makers or appliances that use water lines, particularly coffee or beverage makers that are mounted on board passenger transport vehicles. Such coffee makers and appliances are plumbed in-line with the vehicle water system.

### BRIEF DESCRIPTION OF THE DRAWINGS

FIG. 1 shows a schematic view of a hot water venting scheme vent system.

FIG. 2 shows a more detailed schematic of the venting scheme of

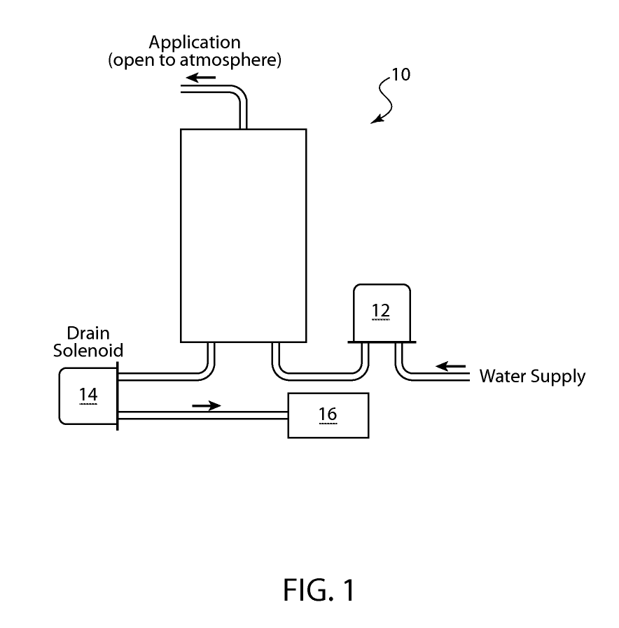

FIG. 1.

### DETAILED DESCRIPTION

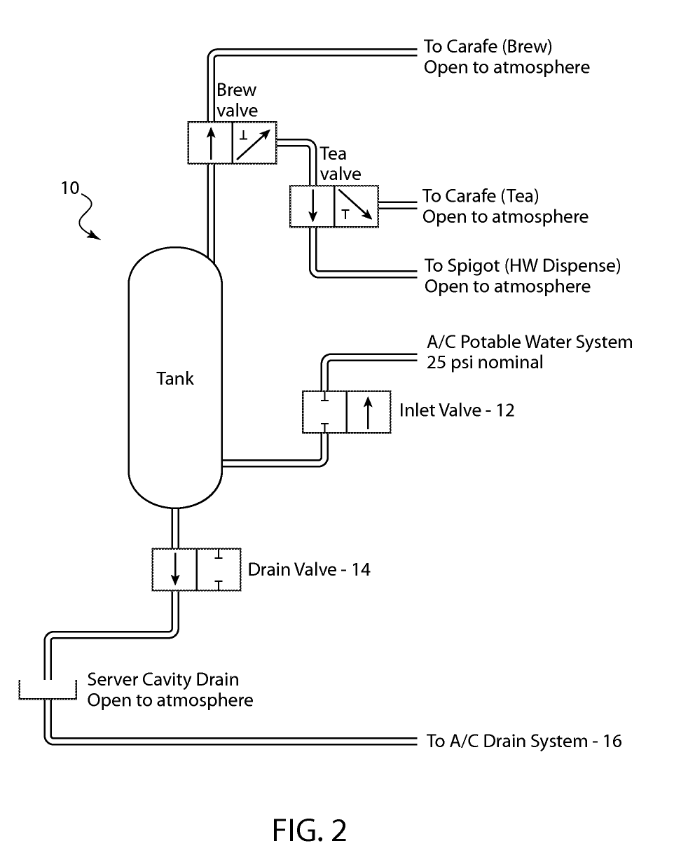

Embodiments of the present invention are directed toward methods and systems for venting coffee makers, espresso makers, hot water brewers, or any other beverage makers or appliances mounted on-board a passenger transport vehicle and that use an on-board water source. As shown in FIGS. 1 and 2, the beverage maker system 10 generally includes an inlet solenoid 12 that allows or disallows water to enter the beverage maker unit, and a drain solenoid 14 that vents any water that is presently in the unit into a drain system. Additional solenoids may be present in order to switch the outgoing water to different applications that the beverage maker could require. For each application, the outgoing water is dispensed in some way, meaning that it is open to normal atmospheric pressure.

Specifically, an inlet solenoid 12 allows a flow of inlet water that supplies the beverage maker with a cold water supply, pushing the heated water out to the desired application in the beverage maker, i.e., to supply hot water for coffee, tea, espresso or other beverage brewing. To dispense hot water, the beverage maker will open the inlet solenoid 12 to begin water flow through the unit as needed. When the hot water request has been fulfilled, the inlet solenoid 12 will close. But rather than allowing unused hot water to remain trapped inside the internal tubing of the beverage maker, the drain solenoid 14 is provided that will then immediately open for a short period of time. Opening of the drain solenoid allows air to enter the system and cause additional exiting movement of the water that would be otherwise trapped.

The solenoids 12, 14 may be programmed to work electronically, such that this sequence happens without any intervention from the user. The electrical trigger of the solenoids causes a mechanical opening and closing, respectively. The opening and closing of each of the inlet 12 and drain 14 solenoids need only be long enough to allow atmospheric air to enter the lines of the system. Each of the solenoids remains open for a slight period of time. In one particular embodiment, a slight period of time not to exceed generally 30 seconds will allow the tubing to drain back into the tank system.

The air may come in through any appropriate part of the systems, such as through the brewhead. In other words, the flow of water through the system is generally as follows: the tube from the tank to the brewhead fills with water in order to deliver dispensing water to the system. When the dispensing has been completed, the inlet solenoid 12 closes and the drain solenoid 14 opens. This allows air on the drain side of the system to enter the beverage maker water line. This amount of air forces water in the line toward the drain system 16. In other words, air is sucked into the line in order to cause it to drain or vent, rather than allowing the water to remain stagnant in the line. The head pressure of the existing water in the unit or system will direct the hot water through the drain solenoid 14 into the drain system 16.

Since the system is open to atmosphere, the only entry for air will be at the supply point (e.g. a hot water faucet, a brewhead), creating a negative pressure in the tubing system. This negative pressure will force the water that is normally trapped inside the tubing system to be drained or vented backwards to the desired point, for example, a water tank in the unit.

Changes and modifications, additions and deletions may be made to the structures and methods recited above and shown in the drawings without departing from the scope or spirit of the invention and the following claims.

What is claimed is:

1. A water venting system for a beverage maker configured for use on-board a passenger transport vehicle, comprising:
(a) a water line for delivering water from an on-board water tank to the beverage maker;
(b) an inlet solenoid configured to remain in an open position while water is being delivered to the beverage maker;
(c) a drain solenoid configured to open in order to vent water into a drain system.

2. The water venting system of claim 1, wherein the drain solenoid is configures to open upon closing of the inlet solenoid.

3. The water venting system of claim 1, wherein the drain solenoid stays open for 30 seconds or less.

4. A beverage maker on-board an aircraft comprising the water venting system of claim 1.
